(19) United States
(12) Patent Application Publication
(10) Pub. No.: US 2018/0121049 A1
(43) Pub. Date: May 3, 2018

(54) TERMINAL DEVICE AND METHOD FOR DISPLAYING IMAGE BY SAME, AND WEB SERVER AND METHOD FOR PROVIDING WEB PAGE BY SAME

(71) Applicant: NAVER CORPORATION, Seongnam-si (KR)

(72) Inventors: Cheol Oh Park, Seongnam-si (KR); Hyo Jung Kim, Seongnam-si (KR); Kyung Hwa Chung, Seongnam-si (KR)

(21) Appl. No.: 15/833,668

(22) Filed: Dec. 6, 2017

Related U.S. Application Data
(63) Continuation of application No. PCT/KR2016/005089, filed on Jun. 1, 2016.

(30) Foreign Application Priority Data
Jun. 19, 2015 (KR) 10-2015-0087329

(51) Int. Cl. G06F 3/0485; G06F 17/30; G06Q 30/02; H04W 88/02

(52) U.S. Cl. CPC G06F 3/0485; H04W 88/02; G06Q 30/0273; G06F 17/30861

(57) ABSTRACT

A method for displaying an image by a terminal device which includes: displaying a webpage on a screen; receiving a scroll input of a user with respect to the displayed webpage; and while moving the webpage according to the scroll input of the user, changing a first image displayed in a predetermined area of the webpage, which moves together with the scrolling of the webpage, into a second image. In other words, the image displayed in the predetermined area is gradually changed into a different image during scrolling, such that the image within the predetermined area is subject to two different types of movement: the scrolling movement and an additional type of movement to change the image (such as 3D rotational movement or sideways movement).

### PRIORITY

This application is a Continuation of International Application No. PCT/KR2016/005089, filed on Jun. 1, 2016, which claims priority to Korean Patent Application No. 10-2015-00873290 filed on Jun. 19, 2015, in the Korean Intellectual Property Office, the entire contents of all of which are incorporated herein by reference.

### TECHNICAL FIELD

The present invention relates to a terminal device and a method for displaying an image by the same, and a web server and a method for providing a webpage by the same.

### BACKGROUND ART

As the connection to a mobile terminal and to a network through the mobile terminal becomes active, companies operating a web server provide various services to a user through a webpage transmitted to a user terminal. For example, portal site vendors provide various information such as weather, dictionaries, performances, travel information, movies, etc., to the user and the user searches for specific information at any time through the webpage to easily and conveniently obtain information desired by the user.

However, since all of the web server companies use webpages of a similar platform, there is a problem in that it is difficult to attract the user's attention to the information or contents contained in the webpage. In particular, even if an advertisement image is included in the webpage, it may be difficult to obtain the user's interest, so it may be difficult for the web server company to improve the advertisement's profitability. Accordingly, there is a need for an effective content providing method which can attract the user's attention. Korean Patent Unexamined Publication No. 10-2001-0026047 provides an example of related art.

### DISCLOSURE

### Technical Problem

A terminal device and a method for displaying an image by the same, and a web server and a method for providing a webpage by the same according to an embodiment of the present invention have been made in an effort to provide contents to a user in such a manner to effectively attract the user's attention.

Further, a terminal device and a method for displaying an image by the same, and a web server and a method for providing a webpage by the same according to an embodiment of the present invention have been made in an effort to provide contents to a user by using a user interface (UI), also known as a graphical user interface (GUI), that may concentrate the user's attention.

In addition, a terminal device and a method for displaying an image by the same, and a web server and a method for providing a webpage by the same according to an embodiment of the present invention have been made in an effort to make it possible to include a plurality of contents in a webpage having a limited area.

Moreover, a terminal device and a method for displaying an image by the same, and a web server and a method for providing a webpage by the same according to an embodiment of the present invention have been made in an effort to enhance advertisement profitability of web server companies.

### Technical Solution

A method for displaying an image by a terminal device according to an aspect of the present invention may include: displaying a webpage on a screen; receiving a scroll input of a user with respect to the displayed webpage; and while moving the webpage according to the scroll input of the user, changing a first image displayed in a predetermined area of the webpage, which moves together with the webpage into a second image.

A terminal device according to another aspect of the present invention may include: a display displaying a webpage on a screen; a user input unit receiving a scroll input of a user with respect to the displayed webpage; and a control unit changing, while moving the webpage according to the scroll input of the user, a first image displayed in a predetermined area of the webpage, which moves together with the webpage into a second image.

A method for providing a webpage by a web server according to an aspect of the present invention may include: receiving a request for a webpage from a terminal device; and providing the webpage to the terminal device according to the request from the terminal device, in which while the webpage is displayed on a screen of the terminal device, the webpage may control the terminal device to change a first image displayed in a predetermined area of the webpage, which moves together with the webpage into a second image while moving the webpage according to a scroll input when the scroll input of a user in the webpage is received.

### Advantageous Effects

A terminal device and a method for displaying an image by the same, and a web server and a method for providing a webpage by the same according to an embodiment of the present invention can provide contents to a user in such a manner as to effectively attract the user's attention.

Further, a terminal device and a method for displaying an image by the same, and a web server and a method for providing a webpage by the same according to an embodiment of the present invention can provide contents to a user by using a user interface (UI) that may concentrate the user's attention.

In addition, a terminal device and a method for displaying an image by the same, and a web server and a method for providing a webpage by the same according to an embodiment of the present invention can make it possible to include a plurality of contents in a webpage having a limited area.

Moreover, a terminal device and a method for displaying an image by the same, and a web server and a method for providing a webpage by the same according to an embodiment of the present invention that can enhance advertisement profitability of web server companies.

### DESCRIPTION OF DRAWINGS

FIG. 1 is a diagram illustrating a terminal device and a web server according to an embodiment of the present invention.

FIG. 2 is a flowchart illustrating a method for displaying an image according to an embodiment of the present invention.

FIGS. 3(A) and 3(B) are exemplary diagrams for describing a scroll input of a user.

FIGS. 4(A) to 4(C) are exemplary diagrams for describing a method for displaying an image according to the present invention.

FIGS. 5(A) to 5(C) are exemplary diagrams for describing a method for displaying an image according to the present invention.

FIG. 6 is a diagram illustrating a plurality of areas set with respect to a screen of a terminal device.

FIG. 7 is a block diagram illustrating a configuration of a terminal device according to an embodiment of the present invention.

FIG. 8 is a flowchart illustrating a method for providing a webpage according to another embodiment of the present invention.

FIG. 9 is a block diagram illustrating a configuration of a web server according to yet another embodiment of the present invention.

### DETAILED DESCRIPTION OF THE VARIOUS EMBODIMENTS

A method for displaying an image by a terminal device according to an aspect of the present invention may include: displaying a webpage on a screen; receiving a scroll input of a user with respect to the displayed webpage; and while moving the webpage according to the scroll input of the user, changing a first image displayed in a predetermined area of the webpage, which moves together with the webpage into a second image.

The present invention may have various modifications and various embodiments and specific embodiments will be illustrated in the drawings and described in detail through the detailed description. However, this does not limit the present invention to the specific embodiments, and it should be understood that the present invention covers all the modifications, equivalents and replacements included within the idea and technical scope of the present invention.

In describing the present invention, a detailed description of related known technologies will be omitted if it is determined that they unnecessarily make the gist of the present invention unclear. In addition, numeral figures (for example, first, second, and the like) used during describing the specification are just identification symbols for distinguishing one element from another element.

Further, in the present specification, if it is described that one component is “connected to” or “accesses” the other component, it is understood that the one component may be directly connected to or may directly access the other component but unless explicitly described to the contrary, another component may be “connected” or “access” between the components.

In addition, in the present specification, in the case of components expressed by ‘unit’, ‘module’, and the like, two or more components may be combined into one component or one component may be divided into two or more components for each more subdivided function. In addition, each of the components described below may additionally perform some or all of the functions that are handled by other components in addition to main functions that the corresponding component is responsible for, and some of the main functions of which the respective components are charge may be exclusively carried out by other components.

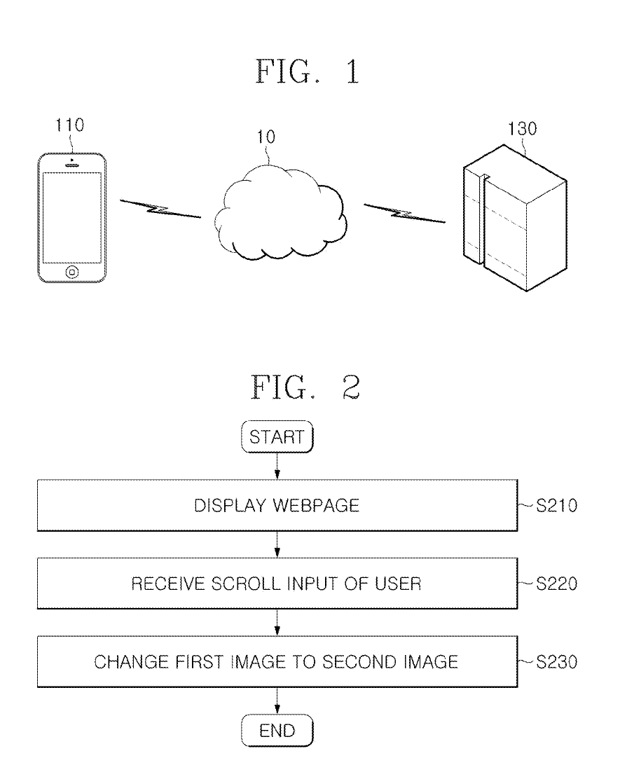

FIG. 1 is a diagram illustrating a terminal device 110 (also referred to as a computer terminal device) and a web server 130 according to an embodiment of the present invention.

As illustrated in FIG. 1, the terminal device 110 and the web server 130 are connected to each other through a network 10. The network 10 may include a wired network and/or a wireless network and in detail, may include various types of networks such as a local area network (LAN), a metropolitan area network (MAN), a wide area network (WAN), and the like. Further, the network 10 may include the world wide web (WWW), which utilizes the internet. However, the network 10 according to the present invention is not limited to the enumerated networks and may include at least at least one of any known wireless data network, any known telephone network, and any known wired/wireless television network.

The terminal device 110 may make a request for a webpage to the web server 130, and upon receipt of the requested webpage, the terminal device will execute the webpage transmitted from the web server 130 through a predetermined application such as a web browser, or the like. The terminal device 110 may receive the webpage from the web server 130 based on an address of the web server 130, which is input by a user.

FIG. 1 illustrates a smart phone as the terminal device 110, but the terminal device 110 according to this embodiment of the present invention may include any of various terminal devices 110, such as a desktop computer, a notebook computer, a PDA, a web pad, a tablet PC, and the like which may execute the web page by using the predetermined application. as well as the smart phone.

When the web server 130 receives the request for the web page from the terminal device 110, the web server 130 transmits the web page to the terminal device 110.

The terminal device 110, according to this embodiment of the present invention, may perform a predetermined function according to the input in the web page by the user, and this feature will be described with reference to FIG. 2.

FIG. 2 is a flowchart illustrating a method for displaying an image according to an embodiment of the present invention.

In step S210, the terminal device 110 displays the webpage on the screen. The terminal device 110 may receive the webpage from the web server 130 and display the webpage on the screen of the terminal device 110 through the predetermined application. The predetermined application includes an application which may perform the functions of the web browser.

In step S220, the terminal device 110 receives the scroll input from the user in the display webpage. The scroll input of the user may include: a touch input on the screen, an input using a mouse, or an input using a keyboard.

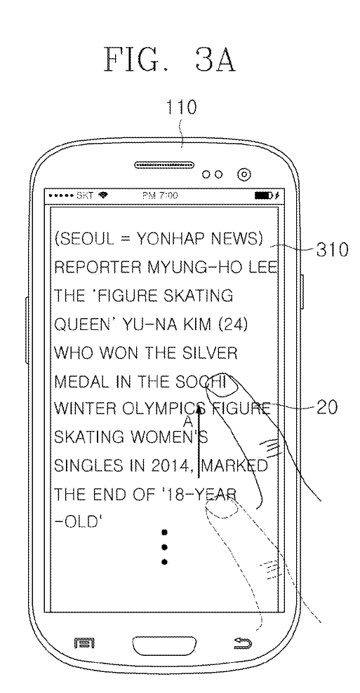

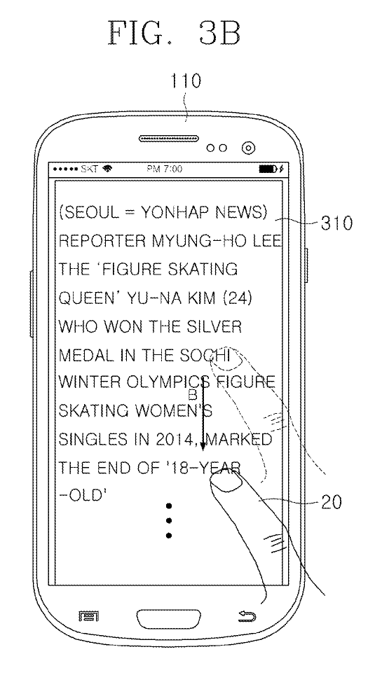

FIGS. 3(A) and 3(B) are diagrams illustrating the scroll input of a user 20, and as illustrated in FIG. 3(a), the user 20 may touch a webpage 310 and thereafter, drag the webpage 310 in an upper direction A in order to move the webpage 310 in the upper direction; and as illustrated in FIG. 3(B), the user 20 may touch the webpage 310 and thereafter, drag the webpage 310 in a lower direction B in order to move the webpage 310 in the lower direction.

Referring back to FIG. 2, in step S230, the terminal device 110 changes a first image displayed in a predetermined area of the webpage, which moves together with the webpage, into a second image while moving the webpage according to the scroll input of the user. The terminal device 110 may gradually change the first image displayed in the predetermined area into the second image as the webpage moves. After the first image displayed in the predetermined area is changed into the second image according to the scroll input by the user in one direction, the terminal device 110 may change the second image back to the first image while moving the webpage when the scroll input in an opposite direction to the one direction is received.

The first image and the second image may include at least one of a still image, a moving picture image, and an animation image. Further, the first image and the second image may include an advertisement image including an image advertisement for an advertiser and a purchase inducement advertisement for a product or a service.

The first image and the second image may be included in the webpage transmitted from the web server 130 and according to an implementation example, the first image and the second image may be images stored in the terminal device 110. When the first image and the second image are the images stored in the terminal device 110, the terminal device 110 may display any one of the images stored in the terminal device 110 in the predetermined area of the webpage while displaying the webpage on the screen, and may change the one image to another image while moving the webpage according to the scroll input.

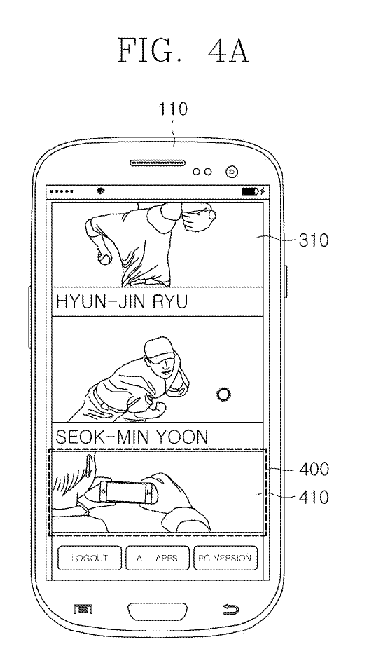

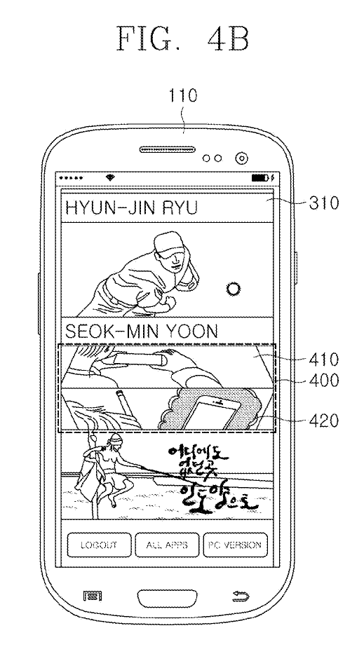

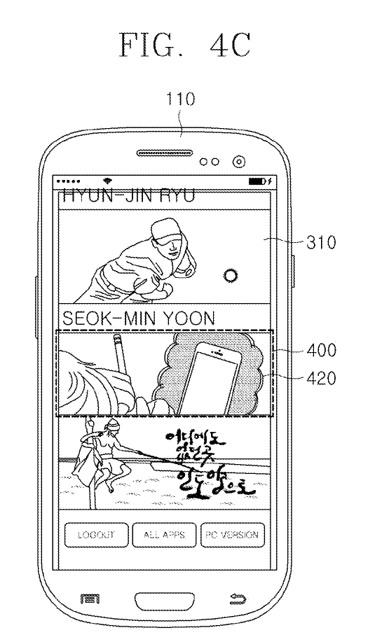

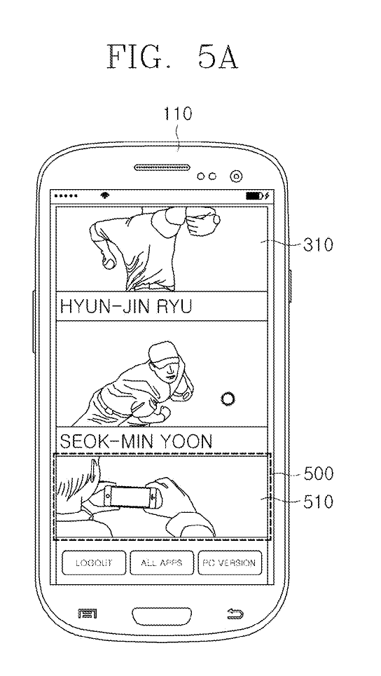

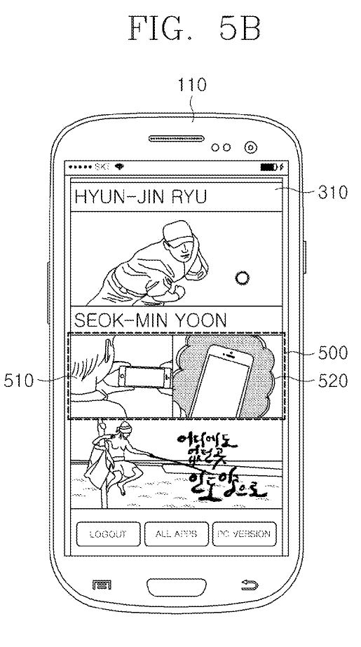

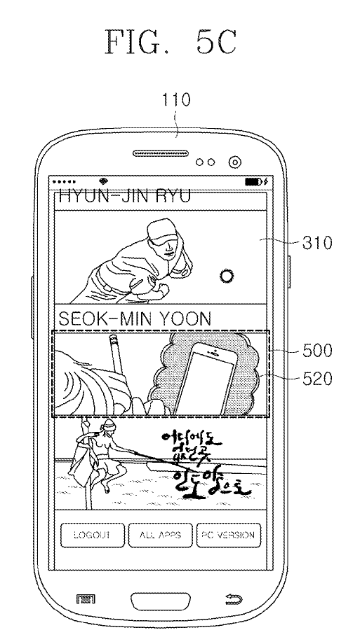

A process of changing the first image into the second image will be described in detail with reference to FIGS. 4 and 5.

Since the terminal device 110 according to this embodiment of the present invention changes the image displayed in the predetermined area, which predetermined area moves together with the webpage while moving the webpage according to the scroll input of the user, the user's attention upon the corresponding image may be enhanced. Further, since a plurality of images may be displayed in one area in a webpage having a limited area, more contents may be included in the webpage than the related art, and/or one area may be used as an advertisement area for a plurality of different advertisers.

FIG. 4(A) to 4(C) are exemplary diagrams for describing a method for displaying an image according to the present invention.

First, as illustrated in FIG. 4(A), the terminal device 110 displays the webpage 310 in which a first image 410 is displayed in a predetermined area 400 on the screen. The predetermined area 400 of the webpage 310 may include a 3D (three dimensional) object 400 consisting of multiple faces, each representing a different plane. That is, as illustrated in FIG. 4(B), the terminal device 110 may rotate the 3D object 400 while moving the webpage 310 in one direction, for example, upward according to the scroll input of the user 20. The first image 410 is displayed on a first plane (i.e., a first face) of the 3D object 400 and the second image 420 is displayed on a second plane (i.e., a second face of the 3D object), and the first image 410 may be gradually changed into the second image 420 together with rotation of the 3D object 400. Last, as illustrated in FIG. 4(C), when rotation of the 3D object 400 is completed from the first plane to the second plane, the second image 420 may be displayed on the screen instead of the first image 410. According to the implementation example, the 3D object 400 may include three or more planes (faces), and the image corresponding to each plane may be displayed on each plane, and also various images may be sequentially displayed on the screen while the 3D object 400 rotates with the up/down movement of the webpage 310.

FIG. 5(A) to 5(C) are exemplary diagrams for describing a method for displaying an image according to the present invention.

Referring to FIGS. 5(A) to 5(C), a predetermined area 500 of the webpage 310 may be a planar object 500, unlike the 3D object 400 of FIGS. 4(A) to 4(C). While a first image 510 is displayed on n the planar object 500 (see FIG. 5(A)) when the webpage 310 moves in one direction, the first image 510 may be gradually reduced in one direction of the planar object 500, for example, towards the left direction, and a second image 520 may be gradually extended in one direction from the other direction, for example, from the right towards the left direction (see FIG. 5(B)). Finally, as illustrated in FIG. 5(C), the second image 520 may be displayed on the planar object 500 instead of the first image 510.

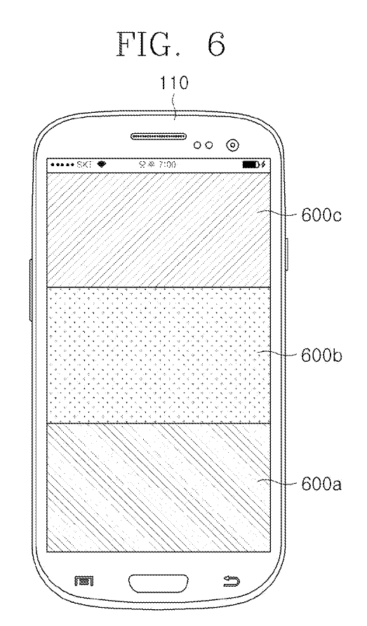

According to the implementation example, the terminal device 110 may previously set an area on the screen, in which various images are displayed, as described below with reference to FIG. 6.

FIG. 6 is a diagram illustrating a plurality of areas 600a, 600b, and 600c set with respect to the screen of the terminal device 110.

As described above, the terminal device 110 may display a plurality of images in the predetermined area while moving the webpage. In this case, the terminal device 110 may previously set the areas 600a, 600b, and 600c on the screen, in which the plurality of images will be displayed, respectively. Referring to FIG. 6, when the predetermined area is positioned in a first area 600a of the screen, the first image may be displayed in the predetermined area, when the predetermined area is positioned in a second area 600b of the screen, the second image may be displayed in the predetermined area, and when the predetermined area is positioned in a third area 600c of the screen, a third image may be displayed in the predetermined area. When the predetermined area is included in both the first area 600a and the second area 600b, the process (see FIGS. 4(B) and 5(B)) of changing the first image into the second image in the predetermined area may be displayed in the predetermined area, and when the predetermined area is included in both the second area 600b and the third area 600c, the process (see FIGS. 4(B) and 5(B)) of changing the second image to the third image in the predetermined image may be displayed in the predetermined area.

In FIG. 6, three areas 600a, 600b, and 600c set for the screen are illustrated, but it will be definitely appreciated by those skilled in the art that the number of areas may be variously changed.

Meanwhile, when the first image and the second image are selected by the user, the terminal device 110 according to this embodiment of the present invention may transmit information indicating that the first image has been selected by the user and information indicating that the second image has been selected by the user to the web server 130. This is to be used as a basis for calculating a billing amount for the advertiser when the first image and the second image are advertisement images.

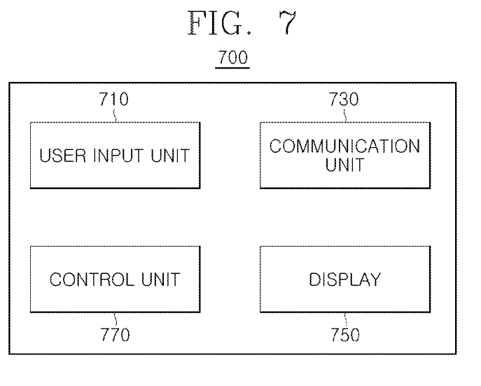

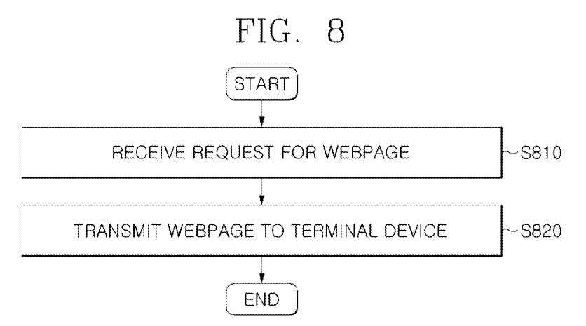

FIG. 7 is a block diagram illustrating a configuration of a terminal device 700 according to an embodiment of the present invention.

Referring to FIG. 7, the terminal device 700 according to this embodiment of the present invention includes a user input unit 710, a communication unit 730, a display 750, and a control unit 770.

First, the user input unit 710 receives an input from the user. The user input unit 710 may include a keyboard, a mouse, or a touch screen. The user may allow the webpage to be displayed on the display through the user input unit 710 or scroll the webpage.

The communication unit 730 receives the webpage from the web server 130. For example, when there is a webpage display request from the user, the communication unit 730 may receive the corresponding webpage from the web server 130 and further, the communication unit 730 may transmit information to the web server 130 indicating that the advertisement image included in the webpage has been selected by the user.

The display 750 displays the webpage on the screen. The predetermined application stored in the terminal device 700 executes the webpage received from the web server 130 to display the executed webpage on the screen of the display 750.

The control unit 770 may be implemented by at least one processor, and it changes the first image displayed in the predetermined area of the webpage into the second image while moving the webpage according to the scroll input received from the user. Since the process of changing the first image into the second image is described above, a detailed description of the process will be omitted.

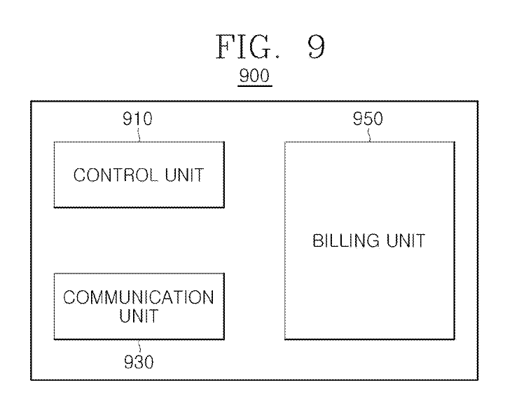

FIG. 8 is a flowchart illustrating a method for providing a webpage according to another embodiment of the present invention.

In step S810, the web server 130 receives the request for the webpage from the terminal device 110. The web server 130 may store the webpage and the webpage may be received from another external r server, and the webpage may have been created by webpage producers. Alternatively, the webpage may be automatically created by the web server 130.

In step S820, the web server 130 transmits the webpage to the terminal device 110 according to the request from the terminal device 110. The web server 130 may transmit the webpage to the terminal device 110 since the web server 130 and the terminal device are connected to each other through the network.

The webpage may include a command or a script for controlling an operation of the terminal device 110. For example, while the webpage is displayed on the screen of the terminal device 110, the webpage may control the terminal device 110 to change the first image displayed in the predetermined area of the webpage into the second image while moving the webpage (up/down) according to the scroll input when the scroll input of the user in the webpage has been received.

Further, the web server 130 may receive the information indicating that the first image was selected by the user, and/or the information indicating that the second image was selected by the user from various terminal devices 110, and the web server 130 may determine the billing amounts for the advertiser corresponding to the first image and the advertiser corresponding into the second image based on the number of times when the first image and the second image are selected by the user.

FIG. 9 is a block diagram illustrating a configuration of a web server 900 according to yet another embodiment of the present invention.

Referring to FIG. 9, the web server 900 according to yet another embodiment of the present invention may include a control unit 910 and a communication unit 930 and may also further include a billing unit 950. The control unit 910, the communication unit 930, and the billing unit 950 may be constituted by one or more processors, and may operate under the control of one or more programs stored in a memory (not illustrated).

First, the control unit 910 controls the operations of the communication unit 930 and the billing unit 950.

The communication unit 930 receives the request for the webpage from the terminal device 110, and the communication unit then transmits the webpage to the terminal device 110 according to the request from the terminal device 110. Further, the communication unit 930 may receive information for determining the billing amount from the terminal device 110.

The billing unit 950 determines the billing amounts for the advertisers according to the information received by the communication unit 930. The billing unit 950 may determine the billing amounts for the advertiser corresponding to the first image and the advertiser corresponding into the second image based on the number of times when the first image is selected by the user and the number of times when the second image is selected by the user in the webpages displayed on the screens of various terminal devices 110.

As described above, the webpage which the web server 900 transmits to the terminal device 110 may control the operation of the terminal device 110. In detail, while the webpage is displayed on the screen of the terminal device 110, the webpage may control the terminal device 110 to change the first image displayed in the predetermined area of the webpage into the second image while moving the webpage (up/down) according to the scroll input when the scroll input of the user in the webpage is received.

A terminal device and a method for displaying an image by the same, and a web server and a method for providing a webpage by the same according to an embodiment of the present invention can provide contents to a user by a manner to effectively attract the user's attention and provide the contents to the user by using a user interface (UI) that may concentrate the user's attention. Moreover, a terminal device and a method for displaying an image by the same, and a web server and a method for providing a webpage by the same according to an embodiment of the present invention can enhance advertisement profitability of web server companies.

Meanwhile, the embodiments of the present invention may be prepared by a computer executable program and implemented by a universal digital computer which operates the program by using a computer readable recording medium.

The computer readable recording medium includes non-transitory storage media such as magnetic storage media (e.g., a ROM, a floppy disk, a hard disk, and the like), and optical reading media (e.g., a CD-ROM, a DVD, and the like), and transitory media such as a carrier wave (e.g., transmission through the Internet).

Hereinabove, the embodiments of the present invention have been described with the accompanying drawings, but it can be understood by those skilled in the art that the present invention can be executed in other detailed forms without changing the technical spirit or requisite features of the present invention. Therefore, it should be appreciated that the aforementioned embodiments are illustrative in all aspects and are not restricted.

1. A method for displaying an image by a terminal device, the method comprising:
displaying a webpage on a screen of the terminal device;
receiving a scroll input from a user with respect to the displayed webpage; and
while moving the webpage according to the scroll input of the user, changing a first image displayed in a predetermined area of the webpage, which moves together with the webpage, into a second image.

2. The method of claim 1, wherein the scroll input of the user is selected from the group consisting of:
a touch input on the screen,
an input using a mouse, and
an input using a keyboard.

3. The method of claim 1, wherein the predetermined area includes a 3D object which rotates while moving according to the scroll input, and
wherein the first image is displayed on a first plane of the 3D object and the second image is displayed on a second plane of the 3D object.

4. The method of claim 1, wherein the changing of the first image into the second image includes gradually changing the first image into the second image while moving the webpage according to the scroll input.

5. The method of claim 4, wherein the gradually changing of the first image into the second image includes gradually extending the second image in one direction from the other direction of the predetermined area while gradually reducing the first image in one direction of the predetermined area.

6. The method of claim 1, wherein the changing of the first image into the second image includes displaying the first image when the predetermined area of the webpage is positioned in a first area of the screen and displaying the second image instead of the first image when the predetermined area is positioned in a second area of the screen.

7. The method of claim 1, wherein the first image and the second image include images stored in the terminal device.

8. The method of claim 1, wherein the first image and the second image include advertisement images of advertisers.

9. The method of claim 8, further comprising:
transmitting to a web server information indicating that the first image is selected by a user and information indicating that the second image is selected by the user.

10. A computer program stored in a medium in order to execute the method for displaying an image of any one of claims 1 to 9 in combination with hardware.

11. A terminal device comprising:
a display displaying a webpage on a screen;
a user input unit receiving a scroll input of a user with respect to the displayed webpage; and
a control unit changing, while moving the webpage according to the scroll input of the user, a first image displayed in a predetermined area of the webpage, which moves together with the webpage into a second image.

12. A method for providing a webpage by a web server, the method comprising:
receiving a request for a webpage from a terminal device; and
providing the webpage to the terminal device according to the request from the terminal device,
wherein while the webpage is displayed on a screen of the terminal device, the webpage controls the terminal device to change a first image displayed in a predetermined area of the webpage, which moves together with the webpage into a second image while moving the webpage according to a scroll input when the scroll input of a user in the webpage is received.

13. The method of claim 12, further comprising:
receiving from various terminal devices information indicating that the first image is selected by the user and information indicating that the second image is selected by the user; and
determining billing amounts for advertisers of the first image and the second image based on the number of times when the first image is selected by the user and the number of times when the second image is selected by the user.

14. A computer program stored on a non-transitory medium in order to execute the method for providing a webpage of claim 12 in combination with hardware.
